(19) United States
(12) Patent Application Publication
(10) Pub. No.: US 2013/0120474 A1
(43) Pub. Date: May 16, 2013

(54) LIGHT SOURCE DEVICE, DISPLAY DEVICE, AND ELECTRONIC APPARATUS

(71) Applicants: Hiromasa Suzuki, Kanagawa (JP); Mamoru Suzuki, Tokyo (JP)

(72) Inventors: Hiromasa Suzuki, Kanagawa (JP); Mamoru Suzuki, Tokyo (JP)

(73) Assignee: Sony Corporation, Tokyo (JP)

(21) Appl. No.: 13/667,517

(22) Filed: Nov. 2, 2012

(30) Foreign Application Priority Data
Nov. 10, 2011 (JP) 2011-246806

(51) Int. Cl. G02F 1/01; G09G 5/10; F21V 8/00

(52) U.S. Cl. CPC G02F 1/0105; G02B 6/0036; G09G 5/10
USPC 345/690; 362/628; 362/613; 359/240

(57) ABSTRACT

Disclosed is a display device including a display section configured to display an image and a light source device for emitting light for displaying the image to the display section. The light source device includes a first light source for applying first illumination light, and a light guide plate having a plurality of scattering areas, the light guide plate emitting the first illumination light applied from a direction of a side of the light guide plate to an outside by scattering the first illumination light in the plurality of scattering areas, and a light scattering characteristic is added to the scattering areas by forming a plurality of depression and projection shapes in surfaces of the scattering areas or dispersing a light scattering material in the scattering areas, and density of the depression and projection shapes or concentration of the light scattering material in the scattering areas changes according to position.

### BACKGROUND

The present disclosure relates to a light source device and a display device that make stereoscopic vision possible by a parallax barrier system, and an electronic apparatus.

A stereoscopic display device of the parallax barrier system is known, the parallax barrier system being one of stereoscopic display systems that do not require the wearing of special eyeglasses and which make stereoscopic vision with the naked eye possible. This stereoscopic display device has a parallax barrier disposed so as to be opposed to a front surface (display surface side) of a two-dimensional display panel. An ordinary structure of the parallax barrier is formed by alternately arranging, in a horizontal direction, shielding parts for shielding from display image light from the two-dimensional display panel and opening parts (slit parts) in the form of stripes for transmitting the display image light.

In the parallax barrier system, parallax images for stereoscopic vision (a viewpoint image for a right eye and a viewpoint image for a left eye in a case of two viewpoints) are displayed on the two-dimensional display panel in a state of being spatially divided from each other, and the parallax images are separated from each other in a horizontal direction by the parallax barrier, whereby stereoscopic vision is produced. Appropriate settings of slit width and the like in the parallax barrier enable the pieces of light of the different parallax images to be separately made incident on the left eye and the right eye of an observer via a slit section when the observer views the stereoscopic display device from a predetermined position or direction.

Incidentally, when a transmissive type liquid crystal display panel, for example, is used as the two-dimensional display panel, the parallax barrier can also be disposed on the back side of the two-dimensional display panel (see FIG. 10 of Japanese Patent No. 3565391 and FIG. 3 of Japanese Patent Laid-Open No. 2007-187823). In this case, the parallax barrier is disposed between the transmissive type liquid crystal display panel and a backlight.

### SUMMARY

However, the stereoscopic display device of the parallax barrier system requires a dedicated part for three-dimensional display, that is, the parallax barrier, and thus requires a larger number of parts and a larger arrangement space than a display device for ordinary two-dimensional display.

It is desirable to provide a light source device and a display device that realize functions equivalent to those of the parallax barrier using a light guide plate and which provide illumination light of a desired luminance distribution, and an electronic apparatus.

According to an embodiment of the present disclosure, there is provided a light source device including: a first light source for applying first illumination light; and a light guide plate having a plurality of scattering areas, the light guide plate emitting the first illumination light applied from a direction of a side of the light guide plate to an outside by scattering the first illumination light in the plurality of scattering areas. A light scattering characteristic is added to the scattering areas by forming a plurality of depression and projection shapes in surfaces of the scattering areas or dispersing a light scattering material in the scattering areas, and density of the depression and projection shapes or concentration of the light scattering material in the scattering areas changes according to position.

According to an embodiment of the present disclosure, there is provided a display device including:

a display section configured to display an image; and a light source device for emitting light for displaying the image to the display section, the light source device being disposed so as to be opposed to the display section. The light source device is formed by the light source device according to the foregoing embodiment of the present disclosure.

In addition, an electronic apparatus according to an embodiment of the present disclosure includes the display device according to the foregoing embodiment of the present disclosure.

In the light source device, the display device, or the electronic apparatus according to the embodiment of the present disclosure, the first illumination light from the first light source is scattered by the scattering areas, and emitted to the outside of the light guide plate. Thereby the light guide plate itself can be provided with the functions of the parallax barrier for the first illumination light. That is, the light guide plate can be made to function equivalently as a parallax barrier such that the scattering areas form opening parts (slit parts). Thereby provision can be made for three-dimensional display. In addition, because the density of the depression and projection shapes or the concentration of the light scattering material in the scattering areas changes according to position, illumination light of a desired luminance distribution can be obtained.

According to the light source device, the display device, or the electronic apparatus according to the embodiment of the present disclosure, the light guide plate has the plurality of scattering areas for scattering the first illumination light. Therefore the light guide plate itself can be equivalently provided with the functions of the parallax barrier for the first illumination light. In addition, because the density of the depression and projection shapes or the concentration of the light scattering material in the scattering areas changes according to position, illumination light of a desired luminance distribution can be obtained.

### BRIEF DESCRIPTION OF THE DRAWINGS

FIG. 1 is a sectional view showing an example of constitution of a display device according to a first embodiment of the present disclosure together with a state of emission of light rays from a light source device when only a first light source is in an on (lighting) state;

FIG. 2 is a sectional view showing the example of constitution of the display device shown in FIG. 1 together with a state of emission of light rays from the light source device when only a second light source is in an on (lighting) state;

FIG. 3 is a plan view showing an example of pixel structure of a display section;

FIG. 4A is a plan view of a light guide plate in the display device shown in FIG. 1, FIG. 4B is a sectional view of the light guide plate, the sectional view taken in a side direction, FIG. 4C is a diagram of assistance in explaining a basic structure of a scattering area, and FIG. 4D is a diagram of assistance in explaining the density distribution of depression and projection shapes in a scattering area;

FIG. 5A is a plan view of the light guide plate in the display device shown in FIG. 1, FIG. 5B is a sectional view of the light guide plate, the sectional view taken in a side direction, and FIG. 5C is a diagram of assistance in explaining the luminance distribution in an X-direction of the light guide plate;

FIG. 6 is a diagram of assistance in explaining the luminance distribution in the X-direction of a scattering area;

FIG. 7A is a plan view of a light guide plate in a display device according to a comparative example, FIG. 7B is a sectional view of the light guide plate according to the comparative example, the sectional view taken in a side direction, and FIG. 7C is a diagram of assistance in explaining an example of the luminance distribution in a Y-direction of the light guide plate according to the comparative example and the density distribution of depression and projection shapes in the scattering areas of the light guide plate according to the comparative example;

FIG. 8A is a plan view of the light guide plate in the display device shown in FIG. 1, FIG. 8B is a sectional view of the light guide plate, the sectional view taken in the side direction, and FIG. 8C is a diagram of assistance in explaining an example of the luminance distribution in the Y-direction of the light guide plate and the density distribution of depression and projection shapes in the scattering areas of the light guide plate;

FIG. 9 is a diagram of assistance in explaining an example of the density distribution of the depression and projection shapes in the scattering areas;

FIG. 10 is a diagram of assistance in explaining an example of the luminance distribution in the Y-direction of the light guide plate;

FIG. 11A is a plan view of a light guide plate in a display device according to a second embodiment, FIG. 11B is a sectional view of the light guide plate, the sectional view taken in a side direction, FIG. 11C is a diagram of assistance in explaining a basic structure of a scattering area, and FIG. 11D is a diagram of assistance in explaining the concentration distribution of a light scattering material in a scattering area;

FIG. 12A is a plan view of a light guide plate in a display device according to a comparative example, FIG. 12B is a sectional view of the light guide plate according to the comparative example, the sectional view taken in a side direction, and FIG. 12C is a diagram of assistance in explaining an example of the luminance distribution in the Y-direction of the light guide plate according to the comparative example and the concentration distribution of a light scattering material in the scattering areas of the light guide plate according to the comparative example;

FIG. 13A is a plan view of the light guide plate in the display device according to the second embodiment, FIG. 13B is a sectional view of the light guide plate, the sectional view taken in the side direction, and FIG. 13C is a diagram of assistance in explaining an example of the luminance distribution in the Y-direction of the light guide plate and the concentration distribution of the light scattering material in the scattering areas of the light guide plate;

FIG. 14A is a plan view of a light guide plate in a display device according to a first example of constitution of a third embodiment, FIG. 14B is a sectional view of the light guide plate, the sectional view taken in a side direction, and FIGS. 14C, 14D, and 14E are diagrams of assistance in explaining an example of the density distribution of depression and projection shapes in scattering areas;

FIG. 15A is a plan view of a light guide plate in a display device according to a second example of constitution of the third embodiment, FIG. 15B is a sectional view of the light guide plate, the sectional view taken in a side direction, and FIGS. 15C and 15D are diagrams of assistance in explaining an example of the density distribution of depression and projection shapes in scattering areas;

FIG. 16A is a diagram of assistance in explaining an example of the luminance distribution of a part corresponding to FIG. 15C, and FIG. 16B is a diagram of assistance in explaining an example of the luminance distribution of a part corresponding to FIG. 15D;

FIGS. 17A and 17B are sectional views showing an example of constitution of a display device according to a fourth embodiment together with states of emission of light rays from a light source device, FIG. 17A showing the state of emission of light rays at a time of three-dimensional display, and FIG. 17B showing the state of emission of light rays at a time of two-dimensional display;

FIGS. 18A and 18B are sectional views showing an example of constitution of a display device according to a fifth embodiment together with states of emission of light rays from a light source device, FIG. 18A showing the state of emission of light rays at a time of three-dimensional display, and FIG. 18B showing the state of emission of light rays at a time of two-dimensional display;

FIGS. 19A and 19B are sectional views showing an example of constitution of a display device according to a sixth embodiment together with states of emission of light rays from a light source device, FIG. 19A showing the state of emission of light rays at a time of three-dimensional display, and FIG. 19B showing the state of emission of light rays at a time of two-dimensional display; and

FIG. 20 is a diagram showing an external appearance of an example of an electronic apparatus.

### DETAILED DESCRIPTION OF THE PREFERRED EMBODIMENTS

Preferred embodiments of the present disclosure will hereinafter be described in detail with reference to the drawings. Incidentally, description will be made in the following order.

### 1. First Embodiment

An example of a display device using a first light source and a second light source

An example of a constitution in which a luminance distribution is uniformized by changing the density distribution of projections and depressions of scattering areas according to position

### 2. Second Embodiment

An example of a constitution in which a luminance distribution is uniformized by changing the concentration distribution of a light scattering material of scattering areas according to position

### 3. Third Embodiment

An example of a constitution in which angle dependence is imparted to a luminance distribution by changing the density distribution of projections and depressions of scattering areas according to position

### 4. Fourth Embodiment

An example of a display device having scattering areas on a first internal reflection surface

### 5. Fifth Embodiment

An example of a display device using a first light source and an electronic paper

### 6. Sixth Embodiment

An example of a display device using a first light source and a polymer diffuser

### 7. Other Embodiments

An example of constitution of an electronic apparatus and the like

### 1. First Embodiment

### [General Constitution of Display Device]

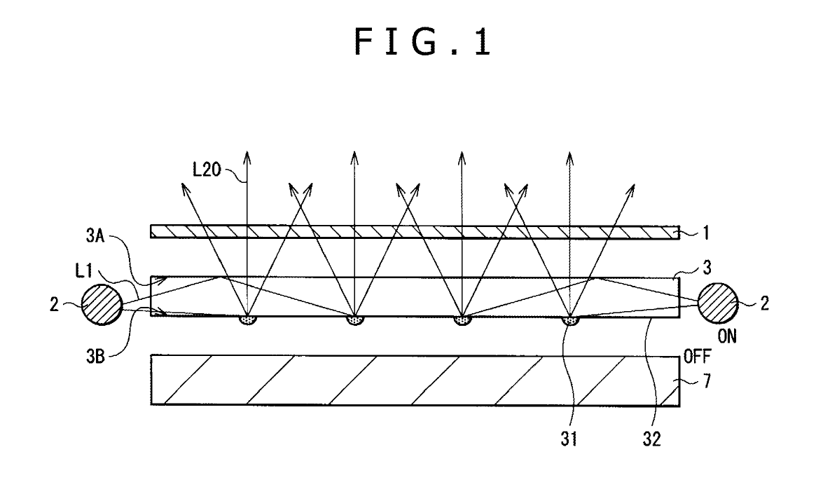

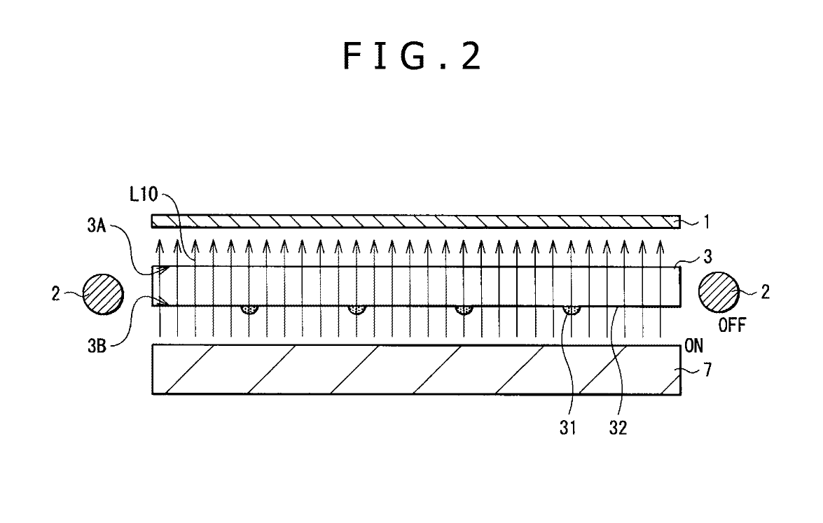

FIG. 1 and FIG. 2 show an example of constitution of a display device according to a first embodiment of the present disclosure. This display device includes a display section 1 for displaying an image and a light source device for emitting light for displaying the image to the display section 1, the light source device being disposed on the back side of the display section 1. The light source device includes a first light source 2 (light source for 2D/3D display), a light guide plate 3, and a second light source 7 (light source for 2D display). The light guide plate 3 has a first internal reflection surface 3A disposed so as to be opposed to the side of the display section 1 and a second internal reflection surface 3B disposed so as to be opposed to the side of the second light source 7. Incidentally, the display device also includes a control circuit and the like for the display section 1 which control circuit and the like are necessary for display. However, the configuration of the control circuit and the like is similar to that of an ordinary control circuit and the like for display, and therefore description thereof will be omitted. In addition, though not shown, the light source device includes a control circuit for performing on (lighting) and off (non-lighting) control of the first light source 2 and the second light source 7.

Incidentally, in the present embodiment, suppose that a first direction (vertical direction) in a plane parallel to the display surface of the display section 1 (surface in which pixels are arranged) or the second internal reflection surface 3B of the light guide plate 3 is a Y-direction, and that a second direction (horizontal direction) orthogonal to the first direction is an X-direction.

The display device can arbitrarily and selectively select a two-dimensional (2D) display mode over the entire screen or a three-dimensional (3D) display mode over the entire screen. The selection of the two-dimensional display mode or the three-dimensional display mode is made possible by performing selection control of image data displayed on the display section 1 and on-off selection control of the first light source 2 and the second light source 7. FIG. 1 schematically shows a state of emission of light rays from the light source device when only the first light source 2 is in an on (lighting) state. This corresponds to the three-dimensional display mode. FIG. 2 schematically shows a state of emission of light rays from the light source device when only the second light source 7 is in an on (lighting) state. This corresponds to the two-dimensional display mode.

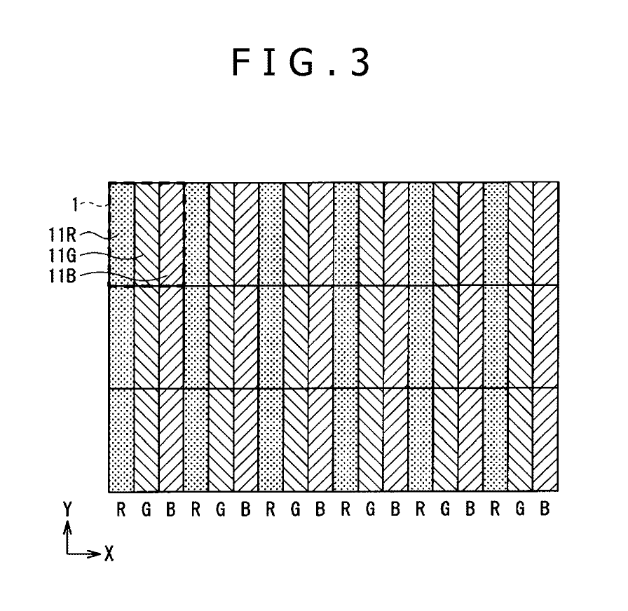

The display section 1 is formed by using a transmissive type two-dimensional display panel, for example a transmissive type liquid crystal display panel. As shown in FIG. 3, for example, the display section 1 has a plurality of pixels including pixels 11R for R (red), pixels 11G for G (green), and pixels 11B for B (blue). The plurality of pixels are arranged in the form of a matrix. The display section 1 makes two-dimensional image display by making the pixels modulate light from the light source device for each color according to the image data. A plurality of viewpoint images based on three-dimensional image data and an image based on two-dimensional image data are arbitrarily and selectively selected and displayed on the display section 1. Incidentally, the three-dimensional image data for example includes the plurality of viewpoint images corresponding to a plurality of viewing angle directions in three-dimensional display. When three-dimensional display of a two-viewpoint system is made, for example, the three-dimensional image data is data of a viewpoint image for right eye display and a viewpoint image for left eye display. When display in the three-dimensional display mode is made, a composite image including a plurality of viewpoint images in the form of stripes is generated and displayed within one screen, for example.

The first light source 2 is for example formed by using a fluorescent lamp such as a CCFL (Cold Cathode Fluorescent Lamp) or the like or an LED (Light Emitting Diode). The first light source 2 irradiates the inside of the light guide plate 3 with first illumination light L1 (FIG. 1) from the direction of a side of the light guide plate 3. At least one first light source 2 is disposed on the side of the light guide plate 3. When the planar shape of the light guide plate 3 is a quadrangle, for example, the light guide plate 3 has four sides. However, it suffices for the first light source 2 to be disposed on at least one side of the light guide plate 3. FIG. 1 shows an example of constitution in which the first light source 2 is disposed on two sides of the light guide plate 3 which sides are opposed to each other. The first light source 2 is subjected to on (lighting) and off (non-lighting) control according to the selection of the two-dimensional display mode and the three-dimensional display mode. Specifically, the first light source 2 is controlled to be in a lighting state when an image based on three-dimensional image data is displayed on the display section 1 (in the three-dimensional display mode), and is controlled to be in a non-lighting state or a lighting state when an image based on two-dimensional image data is displayed on the display section 1 (in the two-dimensional display mode).

The second light source 7 is disposed so as to be opposed to the side of the light guide plate 3 in which side the second internal reflection surface 3B is formed. The second light source 7 irradiates the light guide plate 3 with second illumination light L10 from a direction different from that of the first light source 2. More specifically, the second light source 7 irradiates the second internal reflection surface 3B with the second illumination light L10 from the outside (back side of the light guide plate 3) (see FIG. 2). It suffices for the second light source 7 to be a planar light source that emits light of uniform in-plane luminance. The structure itself of the second light source 7 is not limited to a particular structure. A commercially available planar backlight can be used as the second light source 7. The second light source 7 may have for example a structure formed by using a luminous body such as a CCFL, an LED, or the like and a light diffuser for uniformizing the in-plane luminance. The second light source 7 is subjected to on (lighting) and off (non-lighting) control according to the selection of the two-dimensional display mode and the three-dimensional display mode. Specifically, the second light source 7 is controlled to be in a non-lighting state when an image based on three-dimensional image data is displayed on the display section 1 (in the three-dimensional display mode), and is controlled to be in a lighting state when an image based on two-dimensional image data is displayed on the display section 1 (in the two-dimensional display mode).

The light guide plate 3 is for example formed by a transparent plastic plate such as an acrylic resin or the like. The whole of the surfaces of the light guide plate 3 is transparent except the second internal reflection surface 3B. For example, when the planar shape of the light guide plate 3 is a quadrangle, the whole of the first internal reflection surface 3A and the four sides of the light guide plate 3 is transparent.

The whole of the first internal reflection surface 3A has been subjected to mirror surface processing. The first internal reflection surface 3A effects internal total reflection of light rays made incident at an angle of incidence satisfying a total reflection condition within the light guide plate 3, and emits light rays that fall outside the total reflection condition to the outside.

The second internal reflection surface 3B has scattering areas 31 and total reflection areas 32. As will be described later, a light scattering characteristic is added to the scattering areas 31 by applying laser processing, sandblast processing, or the like to the surface of the light guide plate 3. In the three-dimensional display mode, the scattering areas 31 of the second internal reflection surface 3B function as opening parts (slit parts) of a parallax barrier for the first illumination light L1 from the first light source 2, and the total reflection areas 32 of the second internal reflection surface 3B function as shielding parts of the parallax barrier for the first illumination light L1 from the first light source 2. The scattering areas 31 and the total reflection areas 32 in the second internal reflection surface 3B are disposed in such a pattern as to form a structure corresponding to the parallax barrier. That is, the total reflection areas 32 are disposed in a pattern corresponding to the shielding parts in the parallax barrier, and the scattering areas 31 are disposed in a pattern corresponding to the opening parts in the parallax barrier. Incidentally, various types of patterns such for example as a pattern in the form of stripes such that a large number of opening parts in the shape of vertically long slits are arranged in parallel with each other in the horizontal direction with shielding parts interposed between the opening parts can be used as the barrier pattern of the parallax barrier. The barrier pattern of the parallax barrier is not limited to a particular pattern.

The first internal reflection surface 3A and the total reflection areas 32 in the second internal reflection surface 3B effect internal total reflection of light rays made incident at an angle of incidence θ1 satisfying the total reflection condition (effect internal total reflection of light rays made incident at the angle of incidence θ1 larger than a predetermined critical angle α). Thereby, the first illumination light L1 from the first light source 2 which light is made incident at the angle of incidence θ1 satisfying the total reflection condition is guided in a side direction between the first internal reflection surface 3A and the total reflection areas 32 in the second internal reflection surface 3B by the internal total reflection. As shown in FIG. 2, the total reflection areas 32 also transmit the second illumination light L10 from the second light source 7, and emit the second illumination light L10 as light rays that fall outside the total reflection condition to the first internal reflection surface 3A.

Incidentally, letting n1 be the index of refraction of the light guide plate 3, and letting n0 (<n1) be the index of refraction of a medium (air layer) on the outside of the light guide plate 3, the critical angle α is expressed as follows. Suppose that α and θ1 are angles with respect to a normal to the surface of the light guide plate. The angle of incidence θ1 satisfying the total reflection condition is θ1>α.

sin α=n0/n1

As shown in FIG. 1, the scattering areas 31 scatter and reflect the first illumination light L1 from the first light source 2, and emit at least a part of the first illumination light L1 to the first internal reflection surface 3A as light rays that fall outside the total reflection condition (scattered light rays L20).

Incidentally, for spatial separation of the plurality of viewpoint images displayed on the display section 1 in the display device shown in FIG. 1, the pixel section of the display section 1 and the scattering areas 31 of the light guide plate 3 need to be disposed so as to be opposed to each other with a predetermined distance therebetween maintained. There is an air interval between the display section 1 and the light guide plate 3 in FIG. 1. However, a spacer may be disposed between the display section 1 and the light guide plate 3 to maintain the predetermined distance. In this case, it suffices for the spacer to be a material that is colorless and transparent and which causes a small amount of scattering, and PMMA, for example, can be used as the spacer. The spacer may be disposed so as to cover the whole of the surface on the back side of the display section 1 and the surface of the light guide plate 3, or may be disposed partially as a minimum part necessary to maintain the predetermined distance. In addition, the overall thickness of the light guide plate 3 may be increased to eliminate the air interval.

### [Basic Operation of Display Device]

When the display device makes display in the three-dimensional display mode, the display section 1 displays an image on the basis of three-dimensional image data, and on (lighting) and off (non-lighting) control of the first light source 2 and the second light source 7 is performed for the three-dimensional display. Specifically, as shown in FIG. 1, the first light source 2 is set in an on (lighting) state, and the second light source 7 is controlled to be in an off (non-lighting) state. In this state, the first illumination light L1 from the first light source 2 is repeatedly subjected to internal total reflection between the first internal reflection surface 3A and the total reflection areas 32 of the second internal reflection surface 3B in the light guide plate 3, thereby guided from one side where the first light source 2 is disposed to the other opposed side, and emitted from the other side. Meanwhile, a part of the first illumination light L1 produced by the first light source 2 is scattered and reflected by the scattering areas 31 of the light guide plate 3, thereby passed through the first internal reflection surface 3A of the light guide plate 3, and emitted to the outside of the light guide plate 3. Thereby the light guide plate 3 itself can be provided with the functions of the parallax barrier. That is, the light guide plate 3 can be made to function equivalently as a parallax barrier such that the scattering areas 31 form opening parts (slit parts) for the first illumination light L1 produced by the first light source 2 and the total reflection areas 32 form shielding parts for the first illumination light L1 produced by the first light source 2. Three-dimensional display by the parallax barrier system in which the parallax barrier is disposed on the back side of the display section 1 is thereby made equivalently.

When display is performed in the two-dimensional display mode, on the other hand, the display section 1 displays an image on the basis of two-dimensional image data, and on (lighting) and off (non-lighting) control of the first light source 2 and the second light source 7 is performed for the two-dimensional display. Specifically, as shown in FIG. 2, the first light source 2 is set in an off (non-lighting) state, and the second light source 7 is controlled to be in an on (lighting) state. In this state, the second illumination light L10 produced by the second light source 7 passes through the total reflection areas 32 in the second internal reflection surface 3B, and is thereby emitted as light rays that fall outside the total reflection condition from substantially the whole of the first internal reflection surface 3A to the outside of the light guide plate 3. That is, the light guide plate 3 functions as a planar light source similar to an ordinary backlight. Two-dimensional display by the backlight system in which an ordinary backlight is disposed on the back side of the display section 1 is thereby made equivalently.

Incidentally, when only the second light source 7 is lit, the second illumination light L10 is emitted from substantially the entire surface of the light guide plate 3, but the first light source 2 may be lit as necessary. This makes it possible to optimize a luminance distribution over the entire surface by adjusting the lighting state of the first light source 2 as appropriate (performing on-off control of the first light source 2 or adjusting an amount of lighting of the first light source 2) when a difference in the luminance distribution occurs between parts corresponding to the scattering areas 31 and the total reflection areas 32 when only the second light source 7 is lit, for example. However, the lighting of only the second light source 7 suffices when for example sufficient luminance correction can be made on the side of the display section 1 in the case of two-dimensional display.

### [Concrete Example of Constitution of Scattering Areas 31]

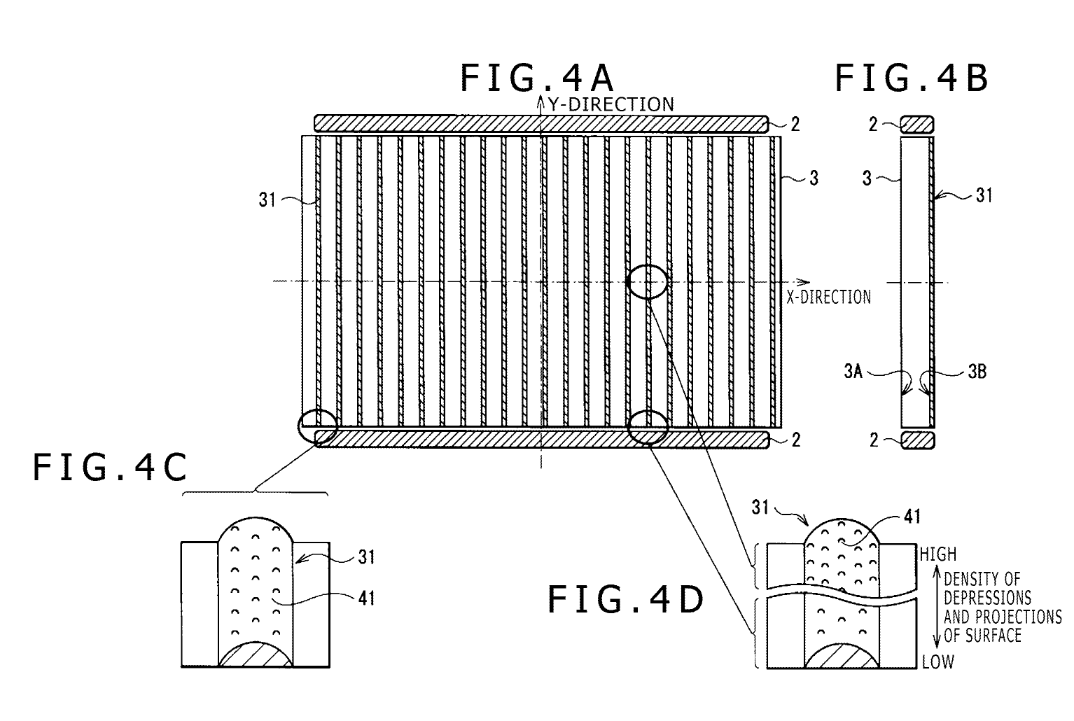

FIGS. 4A to 4D show a concrete example of constitution of the scattering areas 31. The following description will be made by taking as an example a case where first light sources 2 are disposed so as to be opposed to each other on a first side and a second side in the Y-direction of the light guide plate 3, as shown in FIGS. 4A and 4B.

As shown in FIG. 4A, the scattering areas 31 extend in the Y-direction between the first side and the second side, and the plurality of scattering areas 31 are arranged in the X-direction in the form of stripes in parallel with each other. As shown in FIG. 4C, one scattering area 31 has a convex three-dimensional pattern as a whole. A light scattering characteristic is added to the surface (interface) of the three-dimensional pattern by forming a plurality of minute depression and projection shapes 41 in the surface (interface) of the three-dimensional pattern by laser processing or sandblast processing, for example. Further, as shown in FIG. 4D, the density of the depression and projection shapes 41 changes according to distance from the first light sources 2 (distance from the first side and the second side of the light guide plate 3). Specifically, the density of the depression and projection shapes 41 is increased with increasing distance from the first light sources 2. Because the first light sources 2 are disposed on the two sides in the Y-direction, the density of the depression and projection shapes 41 is highest in a central part in the Y-direction. Increasing the density of the depression and projection shapes 41 with increasing distance from the first light sources 2 increases a probability of light hitting the parts of the depression and projection shapes 41 when made incident on the scattering areas 31. When the probability of light hitting the parts of the depression and projection shapes 41 is increased, a probability of the light being diffused and reflected and emitted to the outside of the light guide plate 3 is also increased. That is, luminance is improved.

### (Consideration of Luminance Distribution)

The above constitution can realize a uniform in-plane luminance distribution at a time of three-dimensional display. Consideration will next be given to the luminance distribution of the light guide plate 3. Incidentally, the luminance distribution to be considered in the following refers to a luminance distribution at a time of three-dimensional display, that is, luminance when only the first light source 2 is set in an on (lighting) state.

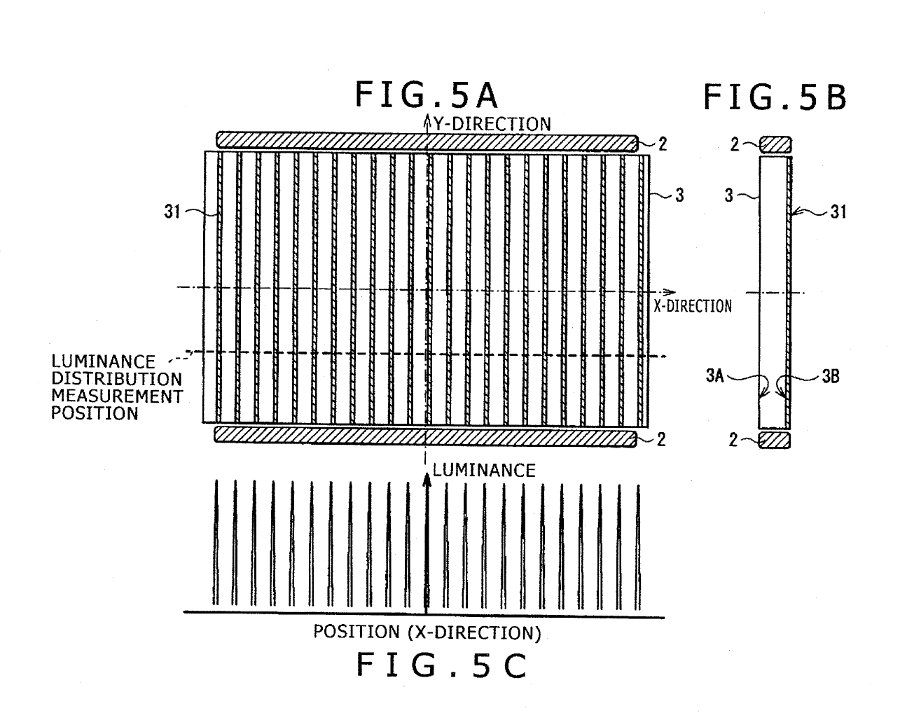

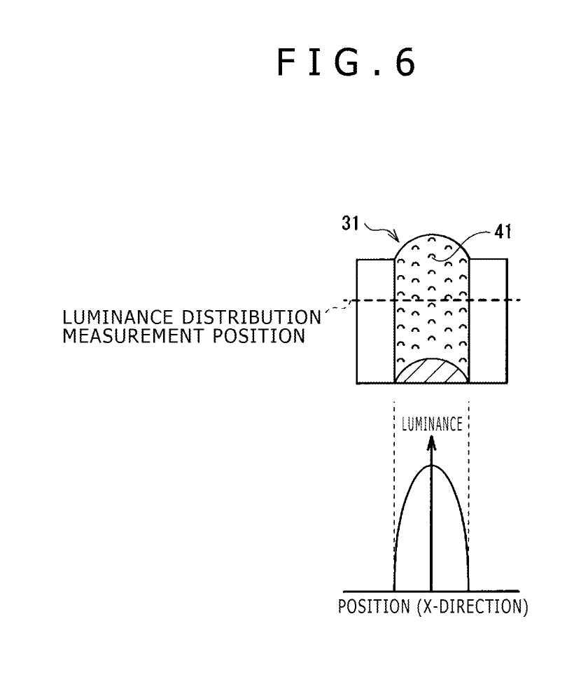

First, with reference to FIGS. 5A to 5C, consideration will be given to a luminance distribution in a direction (X-direction) perpendicular to an extending direction of the three-dimensional patterns of the scattering areas 31. The luminance distribution viewed when the three-dimensional pattern of a scattering area 31 is magnified as in FIG. 6 shows that light is diffused and reflected by only the part of the three-dimensional pattern and emitted to the outside of the light guide plate 3. The light guide plate 3 as a whole thus forms a luminance distribution as shown in FIG. 5C. The discrete light emitting patterns can realize three-dimensional display when combined with the display section 1 of the liquid crystal panel or the like.

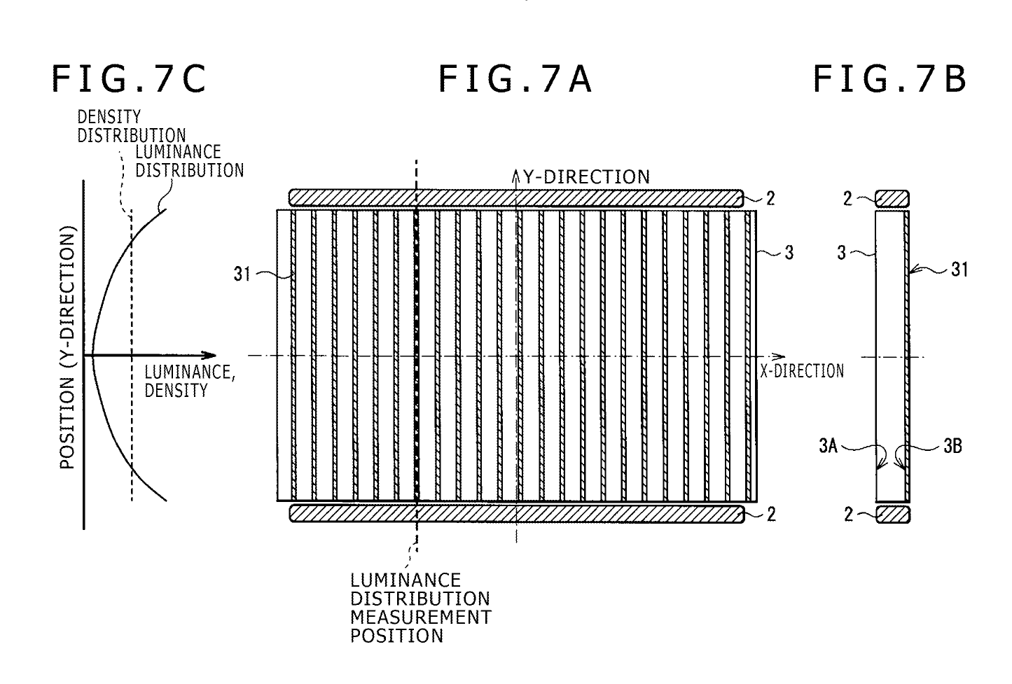

Next, with reference to FIGS. 7A to 10, consideration will be given to a luminance distribution in the extending direction (Y-direction) of the three-dimensional patterns of the scattering areas 31. FIGS. 7A to 7C show a luminance distribution as a comparative example. In the comparative example of FIGS. 7A to 7C, the density distribution of the depression and projection shapes 41 of the scattering area 31 is a uniform distribution in the Y-direction irrespective of distance from the first light sources 2. In a case where the surfaces (interfaces) of the three-dimensional patterns of the scattering areas 31 have such a characteristic as to diffuse and reflect light at a certain ratio when the light hits the three-dimensional patterns, a calculation of the in-plane luminance distribution by using simulation shows that much of the light is emitted in the vicinity of the first light sources 2, as shown in FIG. 7C, when the ratio of the diffusion and reflection is a fixed ratio irrespective of the distance from the first light sources 2. Therefore the in-plane luminance distribution cannot be made uniform.

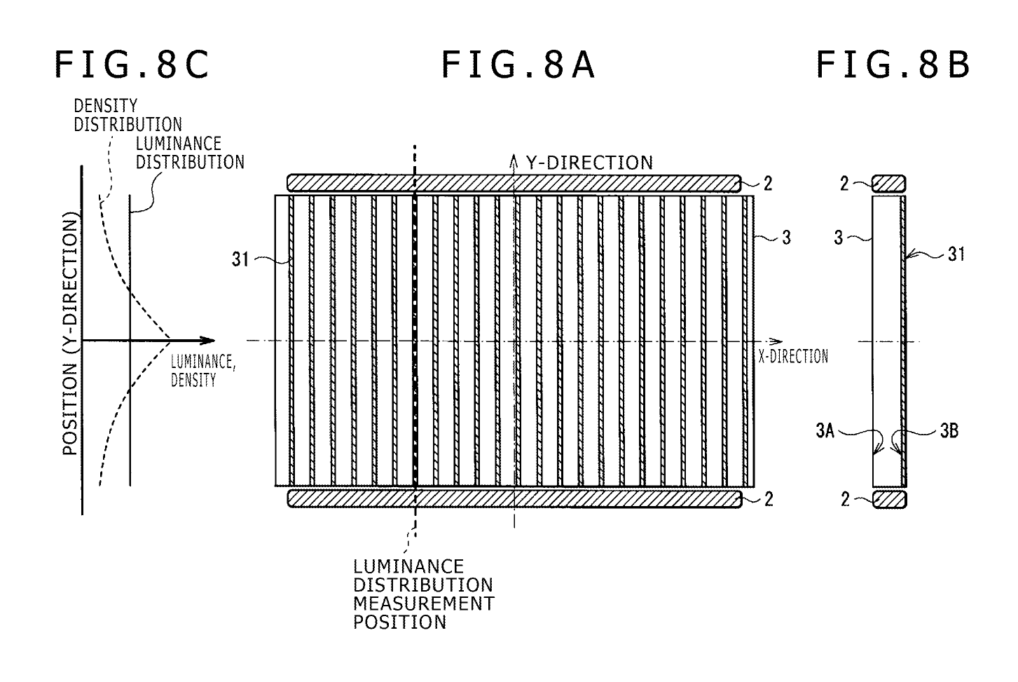

On the other hand, FIG. 8C shows a luminance distribution when the density of the depression and projection shapes 41 of the scattering areas 31 is increased with increasing distance from the first light sources 2. When the density of the depression and projection shapes 41 is increased to raise the ratio of the diffusion and reflection with increasing distance from the first light sources 2, the in-plane luminance distribution can be consequently made uniform as shown in FIG. 8C.

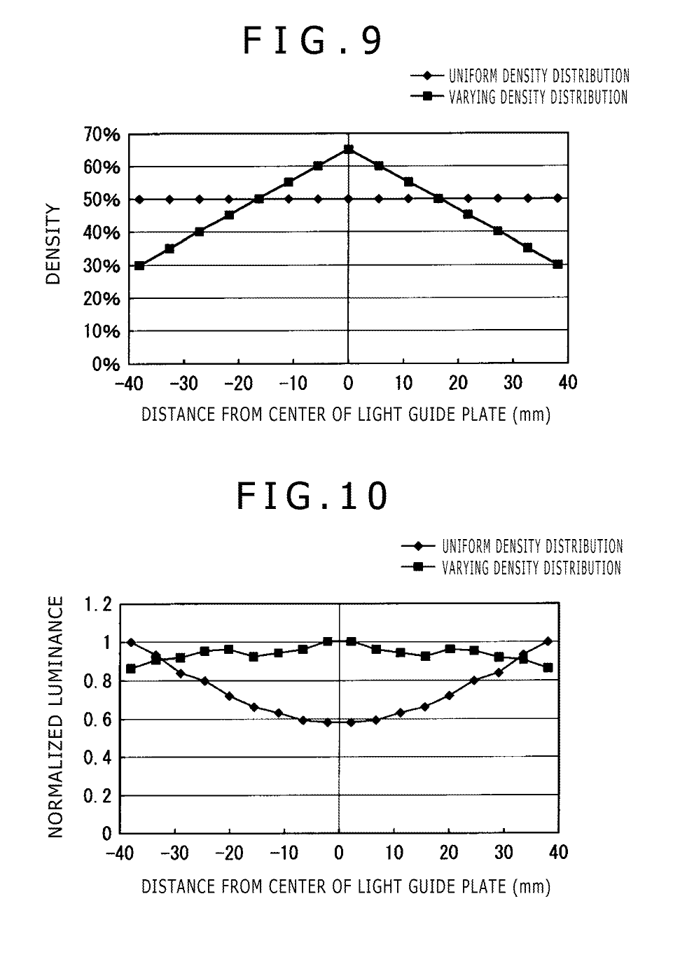

FIG. 9 and FIG. 10 show results of simulation of the luminance distribution. FIG. 9 shows an example of density distributions for comparison between a case where the density distribution of the depression and projection shapes 41 in the scattering areas 31 is made uniform and a case where the density distribution of the depression and projection shapes 41 in the scattering areas 31 is changed. FIG. 10 shows an example for comparison between luminance distributions in the cases where the density distribution is made uniform and where the density distribution is changed as in FIG. 9. As shown in FIG. 10, in the case where the density distribution of the depression and projection shapes 41 is changed, the luminance distribution can be uniformized.

Incidentally, the above description has been made by taking as an example a case where the first light sources 2 are disposed so as to be opposed to the first side and the second side in the Y-direction of the light guide plate 3. In a case where the first light sources 2 are disposed so as to be opposed to the third side and the fourth side in the X-direction of the light guide plate 3, it suffices to change the density distribution of the depression and projection shapes 41 similarly. In the case where the first light sources 2 are disposed in the X-direction, the luminance distribution at a time of three-dimensional display can be uniformized by changing the density distribution in the X-direction according to distance from the first light sources 2.

### [Effect]

As described above, according to the display device in accordance with the present embodiment, the scattering areas 31 and the total reflection areas 32 are provided to the second internal reflection surface 3B of the light guide plate 3, and the first illumination light produced by the first light sources 2 and the second illumination light L10 produced by the second light source 7 can be selectively emitted to the outside of the light guide plate 3. Therefore the light guide plate 3 itself can be equivalently provided with the functions of a parallax barrier. This can reduce the number of parts and achieve space saving as compared with the stereoscopic display device of the conventional parallax barrier system.

In addition, according to the display device in accordance with the present embodiment, the density distribution of the depression and projection shapes 41 of the scattering areas 31 is changed according to distance from the first light sources 2. It is therefore possible to improve the luminance distribution and uniformize the in-plane luminance distribution in three-dimensional display.

### 2. Second Embodiment

A display device according to a second embodiment of the present disclosure will next be described. Incidentally, constituent parts substantially identical to those of the display device according to the foregoing first embodiment are identified by the same reference numerals, and description thereof will be omitted as appropriate.

In the present embodiment, description will be made of an example of modification of the constitution of the scattering areas 31 in the display device according to the foregoing first embodiment.

### [Example of Modification of Scattering Areas 31]

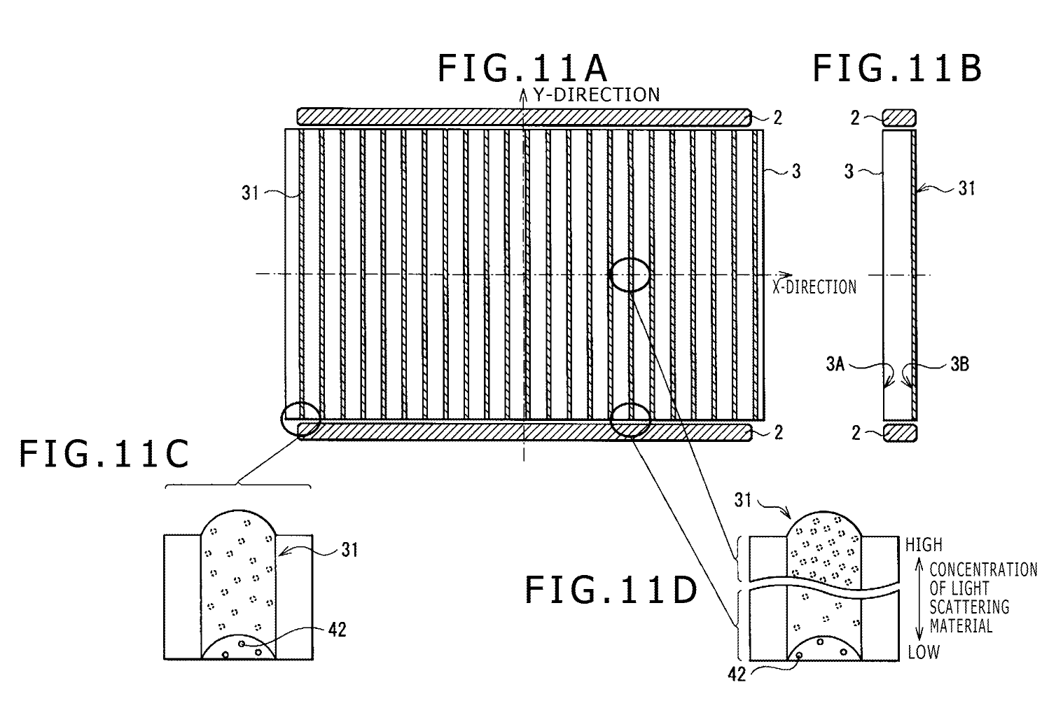

FIGS. 11A to 11D show an example of modification of the scattering areas 31. The following description will be made by taking as an example a case where first light sources 2 are disposed so as to be opposed to the first side and the second side in the Y-direction of a light guide plate 3, as shown in FIGS. 11A and 11B.

In the present modification example, the general shape of the scattering area 31 is similar to FIG. 4A described above. The scattering areas 31 extend in the Y-direction between the first side and the second side, and the plurality of scattering areas 31 are arranged in the X-direction in the form of stripes in parallel with each other. One scattering area 31 has a convex three-dimensional pattern as a whole. In the present modification example, as shown in FIG. 11C, the inside of the three-dimensional pattern of the scattering area 31 is filled with a light scattering material 42. A light scattering characteristic is added to the scattering areas 31 by dispersing the light scattering material 42 in a resin, for example. In the present modification example, depression and projection shapes 41 as in FIG. 4C are not necessarily required. The present modification example can adjust an in-plane luminance distribution by changing the concentration of the light scattering material 42 as shown in FIG. 11D rather than the density of the depression and projection shapes 41 of the surfaces of the three-dimensional patterns. Specifically, the concentration of the light scattering material 42 is increased with increasing distance from the first light sources 2. Because the first light sources 2 are disposed on the two sides in the Y-direction, the concentration is highest in a central part in the Y-direction. Increasing the concentration with increasing distance from the first light sources 2 increases a probability of light being diffused and reflected and emitted to the outside of the light guide plate 3 when the light is made incident on the scattering areas 31. That is, luminance is improved.

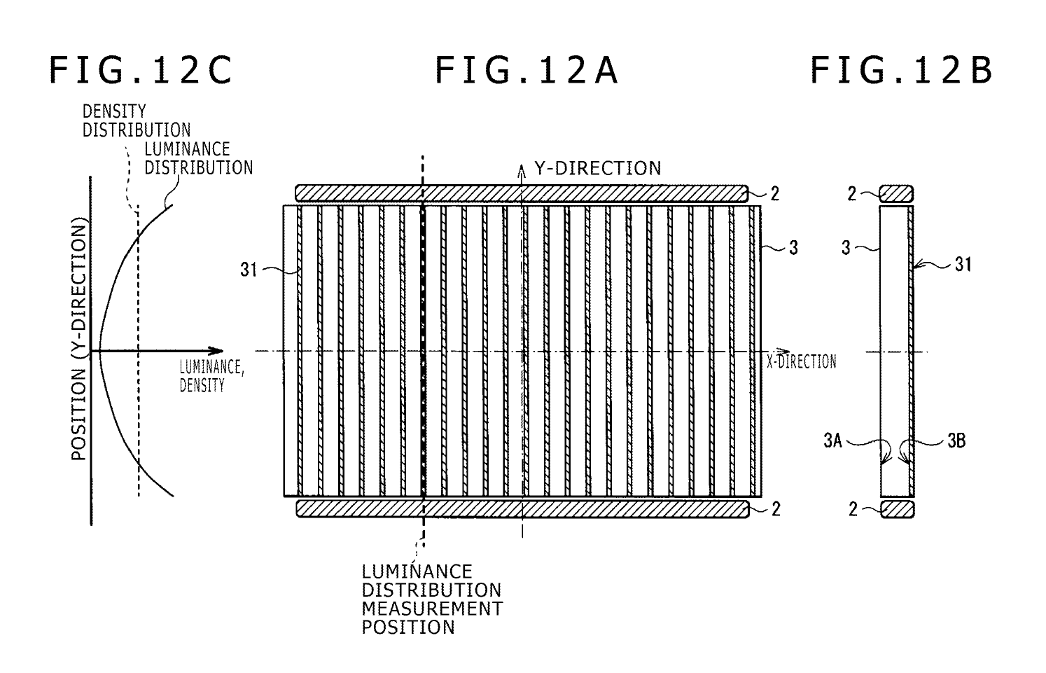

Consideration will be given in the following to a luminance distribution in the extending direction (Y-direction) of the three-dimensional patterns of the scattering areas 31. FIG. 12C shows a luminance distribution as a comparative example. In the comparative example of FIGS. 12A to 12C, the concentration distribution of the light scattering material 42 in the scattering areas 31 is a uniform distribution in the Y-direction irrespective of distance from the first light sources 2. In this case, as shown in FIG. 12C, much light is emitted in the vicinity of the first light sources 2. Thus, the in-plane luminance distribution cannot be made uniform.

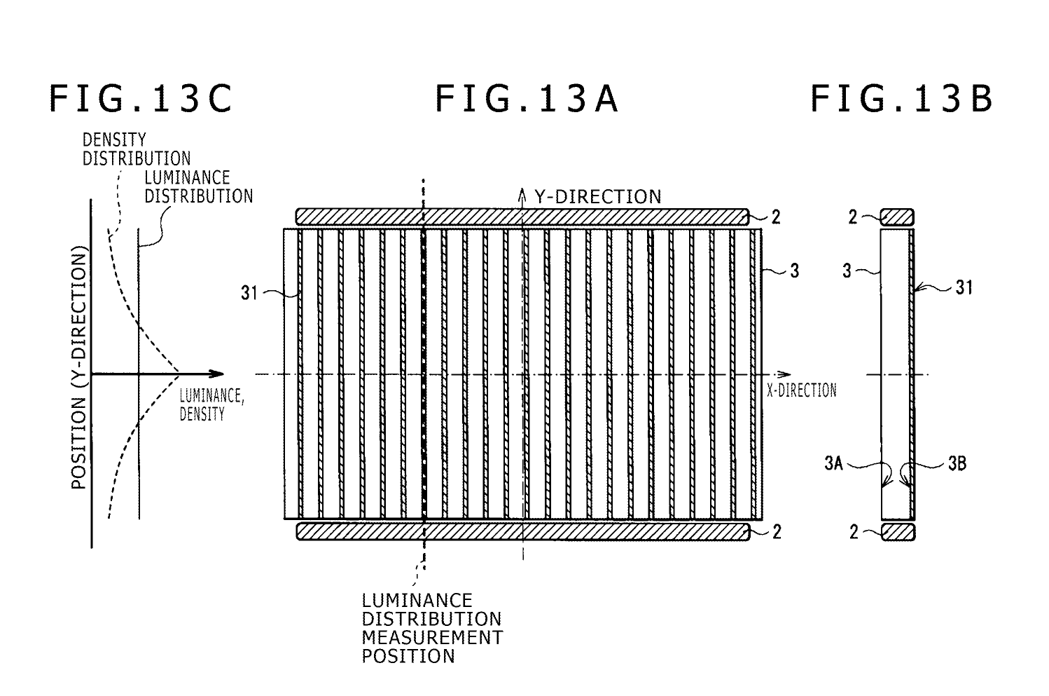

On the other hand, FIG. 13C shows a luminance distribution when the concentration of the light scattering material 42 of the scattering areas 31 is increased with increasing distance from the first light sources 2. When the concentration is increased to raise the ratio of the diffusion and reflection with increasing distance from the first light sources 2, the in-plane luminance distribution can be consequently made uniform as shown in FIG. 13C.

Incidentally, the above description has been made by taking as an example a case where the first light sources 2 are disposed so as to be opposed to the first side and the second side in the Y-direction of the light guide plate 3. In a case where the first light sources 2 are disposed so as to be opposed to the third side and the fourth side in the X-direction of the light guide plate 3, it suffices to change the concentration distribution of the light scattering material 42 similarly. In the case where the first light sources 2 are disposed in the X-direction, the luminance distribution at a time of three-dimensional display can be uniformized by changing the concentration distribution in the X-direction according to distance from the first light sources 2.

### 3. Third Embodiment

A display device according to a third embodiment of the present disclosure will next be described. Incidentally, constituent parts substantially identical to those of the display device according to the foregoing first or second embodiment are identified by the same reference numerals, and description thereof will be omitted as appropriate.

The forgoing first embodiment represents an example in which the density distribution of the depression and projection shapes 41 of the scattering areas 31 is changed to uniformize the luminance distribution. However, as in the following example of constitution, the density distribution of the depression and projection shapes 41 may be changed to impart angle dependence to the luminance distribution.

### [First Example of Constitution]

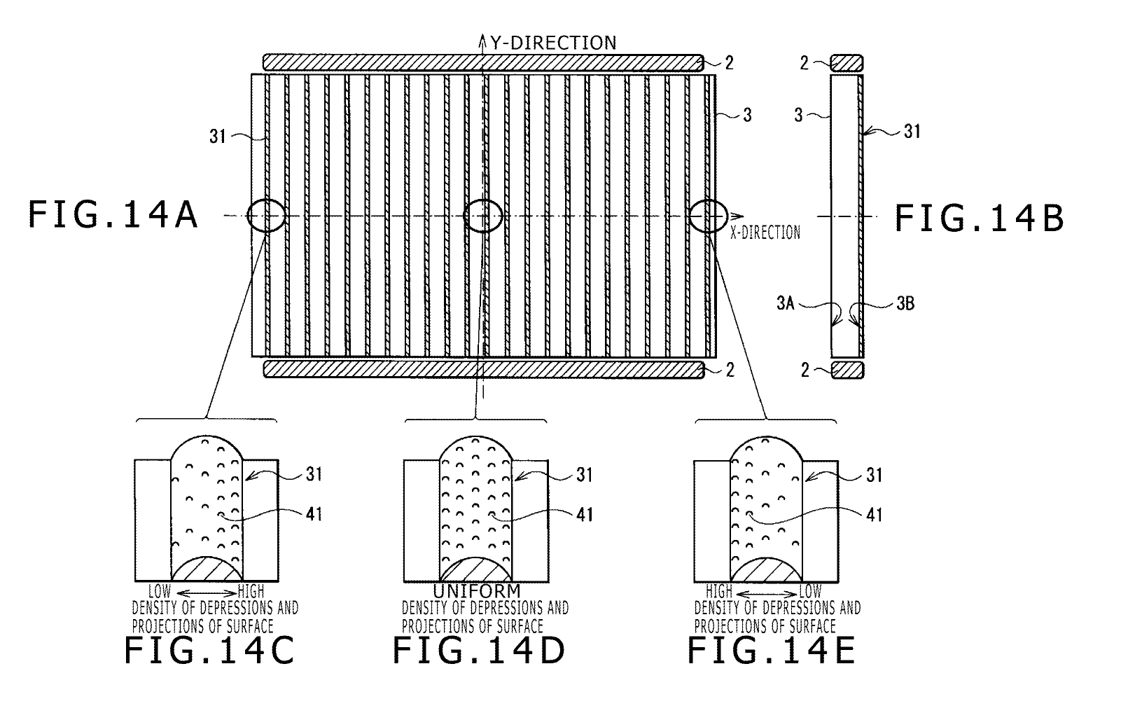

FIGS. 14A to 14E show a first example of constitution of scattering areas 31. In the present modification example, the general shape of the scattering area 31 is similar to FIG. 4A described above. The scattering areas 31 extend in the Y-direction between the first side and the second side, and the plurality of scattering areas 31 are arranged in the X-direction in the form of stripes in parallel with each other. One scattering area 31 has a convex three-dimensional pattern as a whole. A light scattering characteristic is added to the scattering areas 31 by forming a plurality of minute depression and projection shapes 41 in the surfaces (interfaces) of the three-dimensional patterns. Further, as shown in FIGS. 14C to 14E, the density of the depression and projection shapes 41 is changed according to position in the X-direction. Specifically, the density of the depression and projection shapes 41 becomes relatively high in the direction of a central part in the X-direction than in the direction of a peripheral part in the X-direction. For example, as in FIGS. 14C and 14E, as for scattering areas 31 in both side parts in the X-direction, the density of the depression and projection shapes 41 becomes relatively high in the direction of the central part in the X-direction of the three-dimensional patterns. As in FIG. 14D, as for a scattering area 31 located in the central part in the X-direction, the density of the depression and projection shapes 41 is substantially uniform. Thereby angle dependence can be imparted such that the luminance is relatively high as viewed from the direction of a normal to the light emitting surface of the light guide plate 3 and the luminance is relatively low as viewed from a left or right direction at an angle with the normal.

### [Second Example of Constitution]

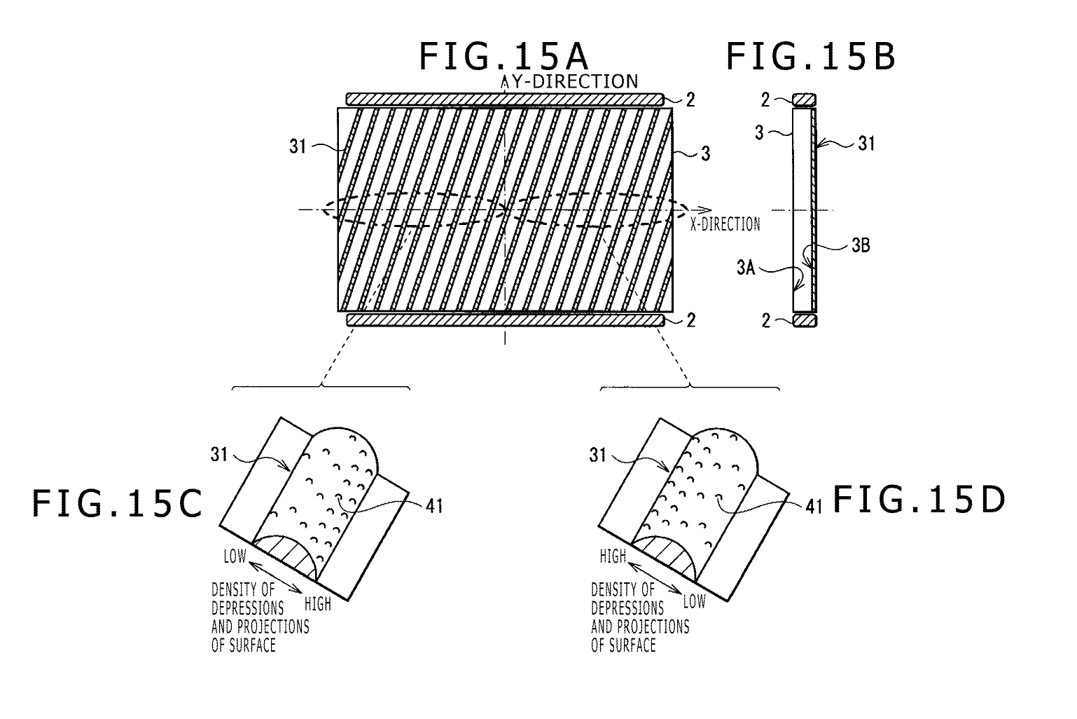

FIGS. 15A to 15D show a second example of constitution of scattering areas 31. In the present modification example, as shown in FIG. 15A, the scattering areas 31 extend obliquely relative to the Y-direction. The plurality of scattering areas 31 extending obliquely are arranged in the X-direction in the form of stripes in parallel with each other. One scattering area 31 has a convex three-dimensional pattern as a whole. A light scattering characteristic is added to the scattering areas 31 by forming a plurality of minute depression and projection shapes 41 in the surfaces (interfaces) of the three-dimensional patterns. Further, as shown in FIGS. 15C and 15D, the density of the depression and projection shapes 41 is changed according to position in the X-direction. Specifically, the density of the depression and projection shapes 41 becomes relatively high in the direction of a central part in the X-direction than in the direction of a peripheral part in the X-direction. For example, as in FIG. 15C, as for a scattering area 31 located in a left side part, the direction of the central part in the X-direction of the three-dimensional patterns is a right side, and the density of the depression and projection shapes 41 becomes relatively high in the right side direction. As in FIG. 15D, as for a scattering area 31 located in a right side part, the direction of the central part in the X-direction of the three-dimensional patterns is a left side, and the density of the depression and projection shapes 41 becomes relatively high in the left side direction. Thereby angle dependence can be imparted such that the luminance is relatively high as viewed from the direction of a normal to the light emitting surface of the light guide plate 3 and the luminance is relatively low as viewed from a left or right direction at an angle with the normal.

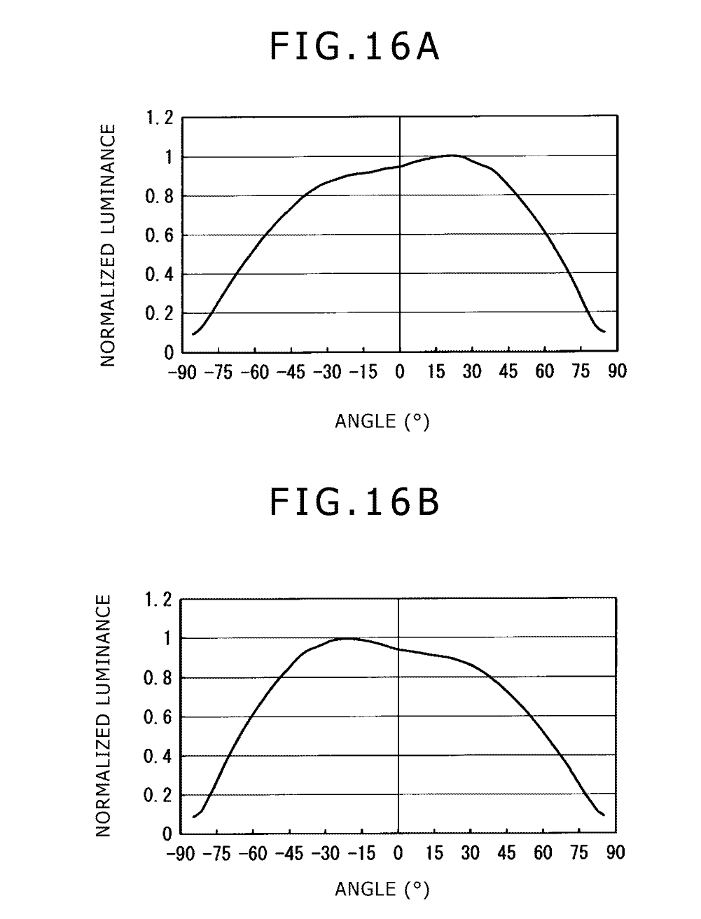

FIG. 16A shows an example of a luminance distribution in the part corresponding to FIG. 15C. FIG. 16B shows an example of a luminance distribution in the part corresponding to FIG. 15D. Thus, angle dependence can be imparted to the luminance distributions.

Incidentally, similar angle dependence can also be imparted by changing the concentration distribution of the light scattering material 42, rather than the density distribution of the depression and projection shapes 41, as in the second embodiment.

### 4. Fourth Embodiment

A display device according to a fourth embodiment of the present disclosure will next be described. Incidentally, constituent parts substantially identical to those of the display devices according to the foregoing first to third embodiments are identified by the same reference numerals, and description thereof will be omitted as appropriate.

### [General Constitution of Display Device]

In the forgoing first embodiment, description has been made of an example of constitution in which the scattering areas 31 and the total reflection areas 32 of the light guide plate 3 are disposed on the side of the second internal reflection surface 3B. However, the scattering areas 31 and the total reflection areas 32 of the light guide plate 3 may be disposed on the side of the first internal reflection surface 3A.

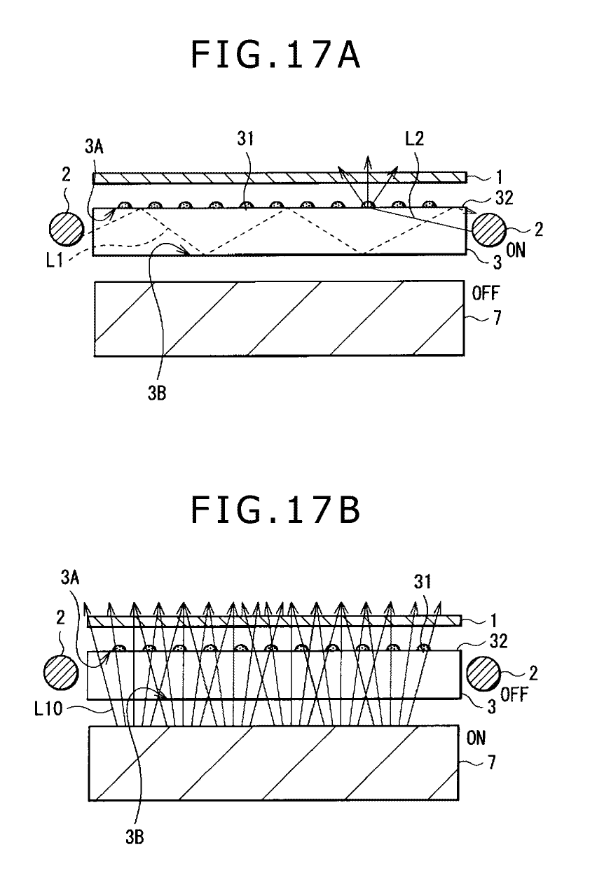

FIGS. 17A and 17B show an example of constitution of the display device according to the fourth embodiment of the present disclosure. As with the display device of FIG. 1, this display device can arbitrarily and selectively select a two-dimensional display mode and a three-dimensional display mode. FIG. 17A corresponds to the constitution in the three-dimensional display mode. FIG. 17B corresponds to the constitution in the two-dimensional display mode. FIGS. 17A and 17B also schematically show states of emission of light rays from a light source device in the respective display modes.

The whole of the second internal reflection surface 3B has been subjected to mirror surface processing. The second internal reflection surface 3B effects internal total reflection of first illumination light L1 made incident at an angle of incidence θ1 satisfying a total reflection condition. The first internal reflection surface 3A has scattering areas 31 and total reflection areas 32. As in the foregoing first or second embodiment, the scattering areas 31 and the total reflection areas 32 in the first internal reflection surface 3A are disposed as to form a structure corresponding to a parallax barrier. Specifically, in the three-dimensional display mode, the scattering areas 31 function as opening parts (slit parts) of the parallax barrier, and the total reflection areas 32 function as shielding parts of the parallax barrier.

The total reflection areas 32 effect internal total reflection of the first illumination light L1 made incident at the angle of incidence θ1 satisfying the total reflection condition (effect internal total reflection of the first illumination light L1 made incident at the angle of incidence θ1 larger than a predetermined critical angle α). The scattering areas 31 emit, to the outside, at least a part of light rays that are included in incident light rays L2 and which are made incident at an angle corresponding to the angle of incidence θ1 satisfying the predetermined total reflection condition in the total reflection areas 32 (emit, to the outside, at least a part of light rays made incident at an angle corresponding to the angle of incidence θ1 larger than the predetermined critical angle α). The scattering areas 31 also effect internal reflection of another part of light rays of the incident light rays L2.

For spatial separation of the plurality of viewpoint images displayed on a display section 1 in the display device shown in FIGS. 17A and 17B, the pixel section of the display section 1 and the scattering areas 31 of the light guide plate 3 need to be disposed so as to be opposed to each other with a predetermined distance therebetween maintained. There is an air interval between the display section 1 and the light guide plate 3 in FIGS. 17A and 17B. However, a spacer may be disposed between the display section 1 and the light guide plate 3 to maintain the predetermined distance.

### [Basic Operation of Display Device]

When the display device makes display in the three-dimensional display mode (FIG. 17A), the display section 1 displays an image on the basis of three-dimensional image data, and a second light source 7 is set in an off (non-lighting) state over the entire surface of the second light source 7. A first light source 2 disposed on the side of the light guide plate 3 is set in an on (lighting) state. In this state, first illumination light L1 from the first light source 2 is repeatedly subjected to internal total reflection between the total reflection areas 32 of the first internal reflection surface 3A and the second internal reflection surface 3B in the light guide plate 3, thereby guided from one side where the first light source 2 is disposed to the other opposed side, and emitted from the other side. Meanwhile, a part of light rays that are included in light rays L2 made incident on the scattering areas 31 of the first internal reflection surface 3A in the light guide plate 3 and which fall outside the total reflection condition are emitted from the scattering areas 31 to the outside. The scattering areas 31 also effect internal reflection of another part of light rays. However, the light rays are emitted to the outside via the second internal reflection surface 3B of the light guide plate 3, and do not contribute to the display of the image. As a result, light rays are emitted from only the scattering areas 31 of the first internal reflection surface 3A in the light guide plate 3. That is, the surface of the light guide plate 3 can be made to function equivalently as a parallax barrier such that the scattering area 31 form opening parts (slit parts) and the total reflection areas 32 form shielding parts. Three-dimensional display by the parallax barrier system in which the parallax barrier is disposed on the back side of the display section 1 is thereby made equivalently.

When display is performed in the two-dimensional display mode (FIG. 17B), on the other hand, the display section 1 displays an image on the basis of two-dimensional image data, and the second light source 7 is set in an on (lighting) state over the entire surface of the second light source 7. The first light source 2 disposed on the side of the light guide plate 3 is set in a non-lighting state, for example. In this state, the second illumination light L10 from the second light source 7 is made incident on the light guide plate 3 via the second internal reflection surface 3B in a state of being substantially close to a vertical direction. Therefore, the angle of incidence of the light rays of the second illumination light L10 falls outside the total reflection condition in the total reflection areas 32, and the light rays are emitted from not only the scattering areas 31 but also the total reflection areas 32 to the outside. As a result, the light rays are emitted from the whole of the first internal reflection surface 3A in the light guide plate 3. That is, the light guide plate 3 functions as a planar light source similar to an ordinary backlight. Two-dimensional display by the backlight system in which an ordinary backlight is disposed on the back side of the display section 1 is thereby made equivalently.

Incidentally, when display in the two-dimensional display mode is made, the first light source 2 disposed on the side of the light guide plate 3 may be controlled to be in an on (lighting) state together with the second light source 7. In addition, when display in the two-dimensional display mode is made, the first light source 2 may be switched to the non-lighting state or the lighting state as necessary. This makes it possible to optimize a luminance distribution over the entire surface by adjusting the lighting state of the first light source 2 as appropriate (performing on-off control of the first light source 2 or adjusting an amount of lighting of the first light source 2) when a difference in the luminance distribution occurs between the scattering areas 31 and the total reflection areas 32 when only the second light source 7 is lit, for example.

### [Effect]

As described above, according to the display device in accordance with the present embodiment, the scattering areas 31 and the total reflection areas 32 are provided to the first internal reflection surface 3A of the light guide plate 3, and the first illumination light produced by the first light sources 2 and the second illumination light L10 produced by the second light source 7 can be selectively emitted to the outside of the light guide plate 3. Therefore the light guide plate 3 itself can be equivalently provided with the functions of a parallax barrier. This can reduce the number of parts and achieve space saving as compared with the stereoscopic display device of the conventional parallax barrier system.

In addition, also in the present embodiment, the luminance distribution in the three-dimensional display can be made to be a desired distribution by making the structure of the scattering areas 31 a constitution similar to that of one of the foregoing first to third embodiments.

### 5. Fifth Embodiment

A display device according to a fifth embodiment of the present disclosure will next be described. Incidentally, constituent parts substantially identical to those of the display devices according to the foregoing first to fourth embodiments are identified by the same reference numerals, and description thereof will be omitted as appropriate.

### [General Constitution of Display Device]

FIGS. 18A and 18B show an example of constitution of the display device according to the fifth embodiment of the present disclosure. The display device has an electronic paper 4 in place of the second light source 7 in the display device of FIGS. 17A and 17B.

The display device can arbitrarily and selectively select a two-dimensional (2D) display mode over the entire screen or a three-dimensional (3D) display mode over the entire screen. FIG. 18A corresponds to the constitution in the three-dimensional display mode. FIG. 18B corresponds to the constitution in the two-dimensional display mode. FIGS. 18A and 18B also schematically show states of emission of light rays from a light source device in the respective display modes.

The electronic paper 4 is disposed on an opposite side from a direction of emission of first illumination light L1 to the outside (on a side on which a second internal reflection surface 3B is formed) so as to be opposed to a light guide plate 3. The electronic paper 4 is an optical device capable of selectively switching action on incident light rays to two states, that is, a light absorbing state and a scattering and reflecting state. The electronic paper 4 is formed by a particle migration type display of an electrophoresis system or an electronic liquid powder system, for example. A particle migration type display makes black display or white display by dispersing black particles positively charged, for example, and white particles negatively charged, for example, between a pair of substrates opposed to each other, and moving the particles according to a voltage applied between the substrates. In particular, the electrophoresis system disperses particles in a solution, and the electronic liquid powder system disperses particles in an air. The above-mentioned light absorbing state corresponds to a black display state over an entire display surface 41 of the electronic paper 4 as shown in FIG. 18A. The scattering and reflecting state corresponds to a white display state over the entire display surface 41 of the electronic paper 4 as shown in FIG. 18B. When a plurality of viewpoint images based on three-dimensional image data are displayed on a display section 1 (in the case of the three-dimensional display mode), the electronic paper 4 sets the action on incident light rays to the light absorbing state. When an image based on two-dimensional image data is displayed on the display section 1 (in the case of the two-dimensional display mode), the electronic paper 4 sets the action on incident light rays to the scattering and reflecting state.

For spatial separation of the plurality of viewpoint images displayed on the display section 1 in the display device shown in FIGS. 18A and 18B, the pixel section of the display section 1 and the scattering areas 31 of the light guide plate 3 need to be disposed so as to be opposed to each other with a predetermined distance therebetween maintained. There is an air interval between the display section 1 and the light guide plate 3 in FIGS. 18A and 18B. However, a spacer may be disposed between the display section 1 and the light guide plate 3 to maintain the predetermined distance.

### [Operation of Display Device]

When the display device makes display in the three-dimensional display mode (FIG. 18A), the display section 1 displays an image on the basis of three-dimensional image data, and the entire display surface 41 of the electronic paper 4 is set in the black display state (light absorbing state). In this state, first illumination light L1 from a first light source 2 is repeatedly subjected to internal total reflection between the total reflection areas 32 of a first internal reflection surface 3A and a second internal reflection surface 3B in the light guide plate 3, thereby guided from one side where the first light source 2 is disposed to the other opposed side, and emitted from the other side. Meanwhile, a part of light rays that are included in light rays L2 made incident on the scattering areas 31 of the first internal reflection surface 3A in the light guide plate 3 and which fall outside the total reflection condition are emitted from the scattering areas 31 to the outside. The scattering areas 31 also effect internal reflection of another part of light rays L3. However, the light rays L3 are made incident on the display surface 41 of the electronic paper 4 via the second internal reflection surface 3B of the light guide plate 3. In this case, because the entire display surface 41 of the electronic paper 4 is in the black display state, the light rays L3 are absorbed by the display surface 41. As a result, light rays are emitted from only the scattering areas 31 of the first internal reflection surface 3A in the light guide plate 3. That is, the surface of the light guide plate 3 can be made to function equivalently as a parallax barrier such that the scattering area 31 form opening parts (slit parts) and the total reflection areas 32 form shielding parts. Three-dimensional display by the parallax barrier system in which the parallax barrier is disposed on the back side of the display section 1 is thereby made equivalently.

When display is performed in the two-dimensional display mode (FIG. 18B), on the other hand, the display section 1 displays an image on the basis of two-dimensional image data, and the entire display surface 41 of the electronic paper 4 is set in the white display state (scattering and reflecting state). In this state, the first illumination light L1 from the first light source 2 is repeatedly subjected to internal total reflection between the total reflection areas 32 of the first internal reflection surface 3A and the second internal reflection surface 3B in the light guide plate 3, thereby guided from one side where the first light source 2 is disposed to the other opposed side, and emitted from the other side. Meanwhile, a part of light rays that are included in the light rays L2 made incident on the scattering areas 31 of the first internal reflection surface 3A in the light guide plate 3 and which fall outside the total reflection condition are emitted from the scattering areas 31 to the outside. The scattering areas 31 also effect internal reflection of another part of light rays L3. However, the light rays L3 are made incident on the display surface 41 of the electronic paper 4 via the second internal reflection surface 3B of the light guide plate 3. In this case, because the entire display surface 41 of the electronic paper 4 is in the white display state, the light rays L3 are scattered and reflected by the display surface 41. The scattered and reflected light rays are made incident on the light guide plate 3 via the second internal reflection surface 3B again. The angle of incidence of the light rays falls outside the total reflection condition in the total reflection areas 32, and the light rays are emitted from not only the scattering areas 31 but also the total reflection areas 32 to the outside. As a result, the light rays are emitted from the whole of the first internal reflection surface 3A in the light guide plate 3. That is, the light guide plate 3 functions as a planar light source similar to an ordinary backlight. Two-dimensional display by the backlight system in which an ordinary backlight is disposed on the back side of the display section 1 is thereby made equivalently.

### [Effect]

As described above, according to the display device in accordance with the present embodiment, the scattering areas 31 and the total reflection areas 32 are provided to the first internal reflection surface 3A of the light guide plate 3. Therefore the light guide plate 3 itself can be equivalently provided with the functions of a parallax barrier. This can reduce the number of parts and achieve space saving as compared with the stereoscopic display device of the conventional parallax barrier system. In addition, switching between the two-dimensional display mode and the three-dimensional display mode can be performed easily by merely changing the display state of the electronic paper 4.

In addition, also in the present embodiment, the luminance distribution in the three-dimensional display can be made to be a desired distribution by making the structure of the scattering areas 31 a constitution similar to that of one of the foregoing first to third embodiments.

### 6. Sixth Embodiment

A display device according to a sixth embodiment of the present disclosure will next be described. Incidentally, constituent parts substantially identical to those of the display devices according to the foregoing first to fifth embodiments are identified by the same reference numerals, and description thereof will be omitted as appropriate.

### [General Constitution of Display Device]

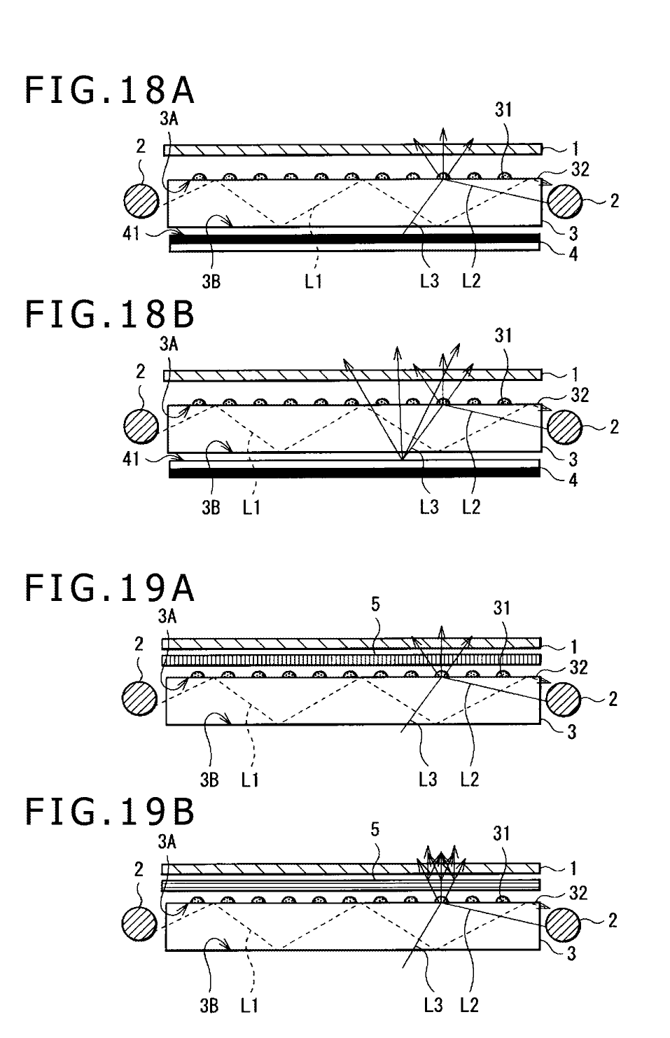

FIGS. 19A and 19B show an example of constitution of the display device according to the sixth embodiment of the present disclosure. As with the display device of FIGS. 18A and 18B, the display device can arbitrarily and selectively select a two-dimensional display mode or a three-dimensional display mode. FIG. 19A corresponds to the constitution in the three-dimensional display mode. FIG. 19B corresponds to the constitution in the two-dimensional display mode. FIGS. 19A and 19B also schematically show states of emission of light rays from a light source device in the respective display modes.

The light source device of the display device has a polymer diffuser 5 in place of the electronic paper 4 in the display device of FIGS. 18A and 18B. The other constitution of the display device is similar to that of the display device of FIGS. 18A and 18B. The polymer diffuser 5 is formed by using a polymer-dispersed liquid crystal. The polymer diffuser 5 is disposed in a direction of emission of first illumination light L1 to the outside (on a side where a first internal reflection surface 3A is formed) so as to be opposed to a light guide plate 3. The polymer diffuser 5 is an optical device capable of selectively switching action on incident light rays to two states, that is, a transparent state and a diffusing and transmitting state according to a voltage applied to a liquid crystal layer.

### [Basic Operation of Display Device]

When the display device makes display in the three-dimensional display mode (FIG. 19A), the display section 1 displays an image on the basis of three-dimensional image data, and the polymer diffuser 5 is set in the transparent state over the entire surface of the polymer diffuser 5. In this state, the first illumination light L1 from a first light source 2 is repeatedly subjected to internal total reflection between the total reflection areas 32 of the first internal reflection surface 3A and a second internal reflection surface 3B in the light guide plate 3, thereby guided from one side where the first light source 2 is disposed to the other opposed side, and emitted from the other side. Meanwhile, a part of light rays that are included in light rays L2 made incident on the scattering areas 31 of the first internal reflection surface 3A in the light guide plate 3 and which fall outside the total reflection condition are emitted from the scattering areas 31 to the outside. The light rays emitted to the outside via the scattering areas 31 are made incident on the polymer diffuser 5. Because the polymer diffuser 5 is in the transparent state over the entire surface of the polymer diffuser 5, the light rays pass through the polymer diffuser 5 as they are in a state of maintaining angles of emission from the scattering areas 31, and enter the display section 1. The scattering areas 31 also effect internal reflection of another part of light rays L3. However, the light rays L3 are emitted to the outside via the second internal reflection surface 3B of the light guide plate 3, and do not contribute to the display of the image. As a result, light rays are emitted from only the scattering areas 31 of the first internal reflection surface 3A in the light guide plate 3. That is, the surface of the light guide plate 3 can be made to function equivalently as a parallax barrier such that the scattering area 31 form opening parts (slit parts) and the total reflection areas 32 form shielding parts. Three-dimensional display by the parallax barrier system in which the parallax barrier is disposed on the back side of the display section 1 is thereby made equivalently.

When display is performed in the two-dimensional display mode (FIG. 19B), on the other hand, the display section 1 displays an image on the basis of two-dimensional image data, and the polymer diffuser 5 is set in the diffusing and transmitting state over the entire surface of the polymer diffuser 5. In this state, the first illumination light L1 from the first light source 2 is repeatedly subjected to internal total reflection between the total reflection areas 32 of the first internal reflection surface 3A and the second internal reflection surface 3B in the light guide plate 3, thereby guided from one side where the first light source 2 is disposed to the other opposed side, and emitted from the other side. Meanwhile, a part of light rays that are included in light rays L2 made incident on the scattering areas 31 of the first internal reflection surface 3A in the light guide plate 3 and which fall outside the total reflection condition are emitted from the scattering areas 31 to the outside. The light rays emitted to the outside via the scattering areas 31 are made incident on the polymer diffuser 5. Because the polymer diffuser 5 is in the diffusing and transmitting state over the entire surface of the polymer diffuser 5, the light rays to be made incident on the display section 1 are diffused by the polymer diffuser 5 over the entire surface. As a result, the light source device as a whole functions as a planar light source similar to an ordinary backlight. Two-dimensional display by the backlight system in which an ordinary backlight is disposed on the back side of the display section 1 is thereby made equivalently.

In addition, also in the present embodiment, the luminance distribution in the three-dimensional display can be made to be a desired distribution by making the structure of the scattering areas 31 a constitution similar to that of one of the foregoing first to third embodiments.

### 7. Other Embodiments

The technology according to the present disclosure is not limited to the description of each of the foregoing embodiments, but is susceptible of various modified embodiments.

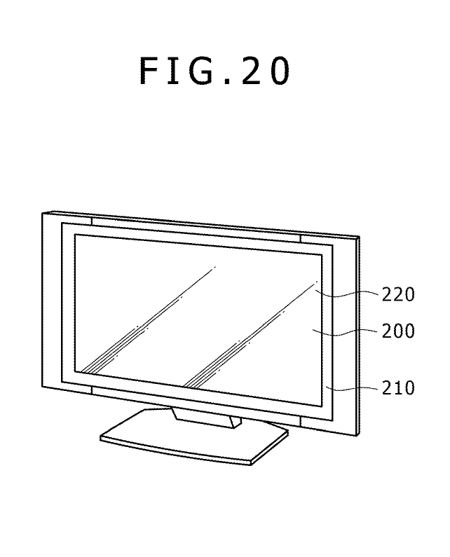

For example, each of the display devices according to the respective foregoing embodiments is applicable to various electronic apparatuses having a display function. FIG. 20 shows an external constitution of a television device as an example of such an electronic apparatus. This television device has a video display screen section 200 including a front panel 210 and a filter glass 220.

In addition, the present technology can adopt the following constitutions, for example.

(1) A display device including:

a display section configured to display an image; and

a light source device for emitting light for displaying the image to the display section;

wherein the light source device includes

a first light source for applying first illumination light, and

a light guide plate having a plurality of scattering areas, the light guide plate emitting the first illumination light applied from a direction of a side of the light guide plate to an outside by scattering the first illumination light in the plurality of scattering areas, and

a light scattering characteristic is added to the scattering areas by forming a plurality of depression and projection shapes in surfaces of the scattering areas or dispersing a light scattering material in the scattering areas, and density of the depression and projection shapes or concentration of the light scattering material in the scattering areas changes according to position.

(2) The display device according to the above (1),

wherein the density of the depression and projection shapes or the concentration of the light scattering material in the scattering areas changes according to distance from the first light source.

(3) The display device according to the above (2),

wherein the density of the depression and projection shapes or the concentration of the light scattering material in the scattering areas increases with increasing distance from the first light source.

(4) The display device according to the above (1),

wherein the density of the depression and projection shapes or the concentration of the light scattering material in the scattering areas becomes relatively higher in a direction of a central part than in a direction of a peripheral part in a horizontal direction.

(5) The display device according to the above (1),

wherein the first light source is disposed so as to be opposed to a predetermined side of the light guide plate, and the density of the depression and projection shapes or the concentration of the light scattering material changes according to distance from the predetermined side.

(6) The display device according to any one of the above (1) to (5),

wherein a plurality of the scattering areas are arranged in a horizontal direction in a form of stripes in parallel with each other.

(7) The display device according to any one of the above (1) to (6), further including a second light source disposed so as to be opposed to the light guide plate, the second light source applying second illumination light to the light guide plate from a direction different from a direction of the first light source.

(8) The display device according to the above (7),

wherein the display section selectively selects and displays a plurality of viewpoint images based on three-dimensional image data and an image based on two-dimensional image data, and

the second light source is controlled to be in a non-lighting state when the display section displays the plurality of viewpoint images, and the second light source is controlled to be in a lighting state when the display section displays the image based on the two-dimensional image data.

(9) The display device according to the above (8),

wherein the first light source is controlled to be in a lighting state when the display section displays the plurality of viewpoint images, and the first light source is controlled to be in a non-lighting state or the lighting state when the display section displays the image based on the two-dimensional image data.

(10) The display device according to any one of the above (1) to (6), further including an optical device disposed on an opposite side from a direction of emission of the first illumination light so as to be opposed to the light guide plate, the optical device being capable of selectively switching action on incident light rays to two states as a light absorbing state and a scattering and reflecting state.

(11) The display device according to any one of the above (1) to (6), further including an optical device disposed in a direction of emission of the first illumination light so as to be opposed to the light guide plate, the optical device being capable of selectively switching action on incident light rays to two states as a transparent state and a diffusing and transmitting state.

(12) A light source device including:

a first light source for applying first illumination light; and

a light guide plate having a plurality of scattering areas, the light guide plate emitting the first illumination light applied from a direction of a side of the light guide plate to an outside by scattering the first illumination light in the plurality of scattering areas;

wherein a light scattering characteristic is added to the scattering areas by forming a plurality of depression and projection shapes in surfaces of the scattering areas or dispersing a light scattering material in the scattering areas, and density of the depression and projection shapes or concentration of the light scattering material in the scattering areas changes according to position.

(13) An electronic apparatus including:

a display device;

wherein the display device includes

a display section configured to display an image, and

a light source device for emitting light for displaying the image to the display section,

the light source device including

a first light source for applying first illumination light, and

a light guide plate having a plurality of scattering areas, the light guide plate emitting the first illumination light applied from a direction of a side of the light guide plate to an outside by scattering the first illumination light in the plurality of scattering areas, and

a light scattering characteristic being added to the scattering areas by forming a plurality of depression and projection shapes in surfaces of the scattering areas or dispersing a light scattering material in the scattering areas, and density of the depression and projection shapes or concentration of the light scattering material in the scattering areas changing according to position.

The present disclosure contains subject matter related to that disclosed in Japanese Priority Patent Application JP 2011-246806 filed in the Japan Patent Office on Nov. 10, 2011, the entire content of which is hereby incorporated by reference.

It should be understood by those skilled in the art that various modifications, combinations, sub-combinations and alterations may occur depending on design requirements and other factors in so far as they are within the scope of the appended claims or the equivalents thereof.

What is claimed is:

1. A display device comprising:
a display section configured to display an image; and
a light source device for emitting light for displaying the image to the display section;
wherein the light source device includes
a first light source for applying first illumination light, and
a light guide plate having a plurality of scattering areas, the light guide plate emitting the first illumination light applied from a direction of a side of the light guide plate to an outside by scattering the first illumination light in the plurality of scattering areas, and
a light scattering characteristic is added to the scattering areas by forming a plurality of depression and projection shapes in surfaces of the scattering areas or dispersing a light scattering material in the scattering areas, and density of the depression and projection shapes or concentration of the light scattering material in the scattering areas changes according to position.

2. The display device according to claim 1,
wherein the density of the depression and projection shapes or the concentration of the light scattering material in the scattering areas changes according to distance from the first light source.

3. The display device according to claim 2,
wherein the density of the depression and projection shapes or the concentration of the light scattering material in the scattering areas increases with increasing distance from the first light source.

4. The display device according to claim 1,
wherein the density of the depression and projection shapes or the concentration of the light scattering material in the scattering areas becomes relatively higher in a direction of a central part than in a direction of a peripheral part in a horizontal direction.

5. The display device according to claim 1,
wherein the first light source is disposed so as to be opposed to a predetermined side of the light guide plate, and the density of the depression and projection shapes or the concentration of the light scattering material changes according to distance from the predetermined side.

6. The display device according to claim 1,
wherein a plurality of the scattering areas are arranged in a horizontal direction in a form of stripes in parallel with each other.

7. The display device according to claim 1, further including a second light source disposed so as to be opposed to the light guide plate, the second light source applying second illumination light to the light guide plate from a direction different from a direction of the first light source.

8. The display device according to claim 7,
wherein the display section selectively selects and displays a plurality of viewpoint images based on three-dimensional image data and an image based on two-dimensional image data, and
the second light source is controlled to be in a non-lighting state when the display section displays the plurality of viewpoint images, and the second light source is controlled to be in a lighting state when the display section displays the image based on the two-dimensional image data.

9. The display device according to claim 8,
wherein the first light source is controlled to be in a lighting state when the display section displays the plurality of viewpoint images, and the first light source is controlled to be in a non-lighting state or the lighting state when the display section displays the image based on the two-dimensional image data.

10. The display device according to claim 1, further including an optical device disposed on an opposite side from a direction of emission of the first illumination light so as to be opposed to the light guide plate, the optical device being capable of selectively switching action on incident light rays to two states as a light absorbing state and a scattering and reflecting state.

11. The display device according to claim 1, further including an optical device disposed in a direction of emission of the first illumination light so as to be opposed to the light guide plate, the optical device being capable of selectively switching action on incident light rays to two states as a transparent state and a diffusing and transmitting state.

12. A light source device comprising:
a first light source for applying first illumination light; and
a light guide plate having a plurality of scattering areas, the light guide plate emitting the first illumination light applied from a direction of a side of the light guide plate to an outside by scattering the first illumination light in the plurality of scattering areas;
wherein a light scattering characteristic is added to the scattering areas by forming a plurality of depression and projection shapes in surfaces of the scattering areas or dispersing a light scattering material in the scattering areas, and density of the depression and projection shapes or concentration of the light scattering material in the scattering areas changes according to position.

13. An electronic apparatus comprising:
a display device;
wherein the display device includes
a display section configured to display an image, and
a light source device for emitting light for displaying the image to the display section,
the light source device including
a first light source for applying first illumination light, and
a light guide plate having a plurality of scattering areas, the light guide plate emitting the first illumination light applied from a direction of a side of the light guide plate to an outside by scattering the first illumination light in the plurality of scattering areas, and
a light scattering characteristic being added to the scattering areas by forming a plurality of depression and projection shapes in surfaces of the scattering areas or dispersing a light scattering material in the scattering areas, and density of the depression and projection shapes or concentration of the light scattering material in the scattering areas changing according to position.
